(19) United States
(12) Patent Application Publication
(10) Pub. No.: US 2012/0117170 A1
(43) Pub. Date: May 10, 2012

(54) SYSTEM AND METHOD FOR PROVIDING A GEO-REFERENCED VIRTUAL COLLABORATIVE ENVIRONMENT

(75) Inventors: Laura J. Brattain, Lexington, MA (US); Ray DiCiaccio, Somerville, MA (US); Jared Pullen, Leominster, MA (US); Andy Vidan, Newton, MA (US)

(73) Assignee: Massachusetts Institute of Technology, Cambridge, MA (US)

(21) Appl. No.: 13/291,973

(22) Filed: Nov. 8, 2011

Related U.S. Application Data
(60) Provisional application No. 61/411,468, filed on Nov. 8, 2010.

(51) Int. Cl. G06F 15/16

(52) U.S. Cl. 709/206

(57) ABSTRACT

A system for providing an image-referenced virtual collaborative environment contains a server in communication with at least a first client device and a second client device, wherein the server comprises a memory and a processor. The processor is configured by the memory to perform the steps of: extracting properties of a vector object, where the vector object is the result of a modification to a first background image performed by a first user on the first client device; placing the extracted properties of the vector object into a feature message; sending the feature message onto a specific topic on a message bus; delivering the feature message to a second user using the second client device; extracting data from the feature message; and rendering, in real time, the vector object on a second background image viewed by the second user via the second client device.

### CROSS-REFERENCE TO RELATED APPLICATION

This application claims priority to copending U.S. Provisional Application entitled, “SYSTEM AND METHOD FOR PROVIDING A GEO-REFERENCED VIRTUAL COLLABORATIVE ENVIRONMENT,” having Ser. No. 61/411,468, filed Nov. 8, 2010, which is entirely incorporated herein by reference.

### FIELD OF THE INVENTION

The present invention is generally related to Internet communications, and more particularly is related to a real-time geo-referenced virtual communications.

### BACKGROUND OF THE INVENTION

Communication between a first user of a computer and a second user of a separate computer, via use of the Internet, has become more user-friendly over time. The sharing of data and images via use of the Internet is presently performed through use of one or more of many different techniques. As an example, a first user may share their computer screen with a second user located at a remote location. One program that provides this means of communication between the first and second user is GoToMeeting, by Citrix Systems, Inc.

In fact, there are many different screen-sharing programs that are presently made available to the public. While such programs provide the convenience of allowing both users to view the same screen, thereby sharing information, there are many disadvantages to screen-sharing programs. As an example, present screen-sharing programs rely upon the first user to maintain the data provided to their screen, which is shared with the remote user. If the first user does not update the data or has corrupt data, the remote user views the antiquated data or may not be able to view the data if it is corrupt. As a result, the remote user is at the mercy of the first user, the reliability of their data, and the stability of their data.

If a layer of complexity is added in which both the first user and the remote user are sharing each of their respective screens with each other, there is the added burden of maintaining data on both the computer of the first user and the computer of the remote user. This is in addition to the burden of reliability and stability of data, as previously mentioned.

Thus, a heretofore unaddressed need exists in the industry to address the aforementioned deficiencies and inadequacies.

### SUMMARY OF THE INVENTION

Embodiments of the present invention provide a system and method for providing an image-referenced virtual collaborative environment. Briefly described, in architecture, one embodiment of the system, among others, can be implemented as follows. The system contains a server in communication with at least a first client device and a second client device, wherein the server comprises a memory and a processor. The processor is configured by the memory to perform the steps of: extracting properties of a vector object, where the vector object is the result of a modification to a first background image performed by a first user on the first client device; placing the extracted properties of the vector object into a feature message; sending the feature message onto a specific topic on a message bus; delivering the feature message to a second user using the second client device; extracting data from the feature message; and rendering, in real time, the vector object on a second background image viewed by the second user via the second client device.

The present invention can also be viewed as providing methods for providing an image-referenced virtual collaborative environment. In this regard, one embodiment of such a method, among others, can be broadly summarized by the following steps: extracting properties of a vector object, where the vector object is the result of a modification to a first background image performed by a first user on a first client device; placing the extracted properties of the vector object into a feature message; sending the feature message onto a specific topic on a message bus; delivering the feature message to a second user using a second client device; extracting data from the feature message; and rendering, in real time, the vector object on a second background image viewed by the second user via the second client device.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating an exemplary network in accordance with the present system and method.

FIG. 2 is a schematic diagram illustrating a server of FIG. 1.

FIG. 3 is a flow chart providing a high-level flow of a user interacting with the present system and method.

FIG. 4 is a flow chart illustrating details and methods for how real-time, geo-referenced collaboration is achieved in accordance with the present invention.

FIG. 5 is an example of the network of a software stack of the server in accordance with an alternative embodiment of the invention.

FIG. 6 is a flow chart further describing steps taken in accordance with blocks 104 and 106 of FIG. 3.

### DETAILED DESCRIPTION

The present invention provides a system and method for use via the Internet that enables more than one user, at physically separate locations, to collaborate. In particular, users are able to conduct geo-referenced (map-centric) virtual discussions because the present system and method provides the ability to share drawings, sketches, icons, images, and other similar data on a shareable map. Users can pan and zoom to specific locations on the map, and the map of all other users will pan and zoom to the same view. Users also have the ability to see who is online and participating in a collaboration room, and to use text chatting or other communication methods within the collaboration room. Data is exchanged in real-time, including map/image interaction. Preferably, this environment is provided through the Web.

It should be noted that while the present description focuses on a map canvas (e.g., background display), and describes the technique as being “geo-referenced,” the present technology described herein can be used to collaborate around a different image (e.g., a building floor plan, an object, etc.) or even a real-time video feed. The present system and method provides the capability to spatially anchor drawings and data of a user to the canvas background and exchange these messages in real-time.

It should also be noted that while the present description refers to providing a Web application, the present system and method is not limited to being provided as a Web application stored at a server. The present description provides for software providing the functionality of the present invention to be stored on a server, with users communicating with the server from a remote location. This network configuration is not intended to be a limitation of the present invention. A different communication configuration may instead be provided, as long as multiple users may view, manipulate, and communicate regarding the same image, while using separate computers. Herein, a computer is considered to be any device having a memory and a processor that is capable of performing the functions as defined herein.

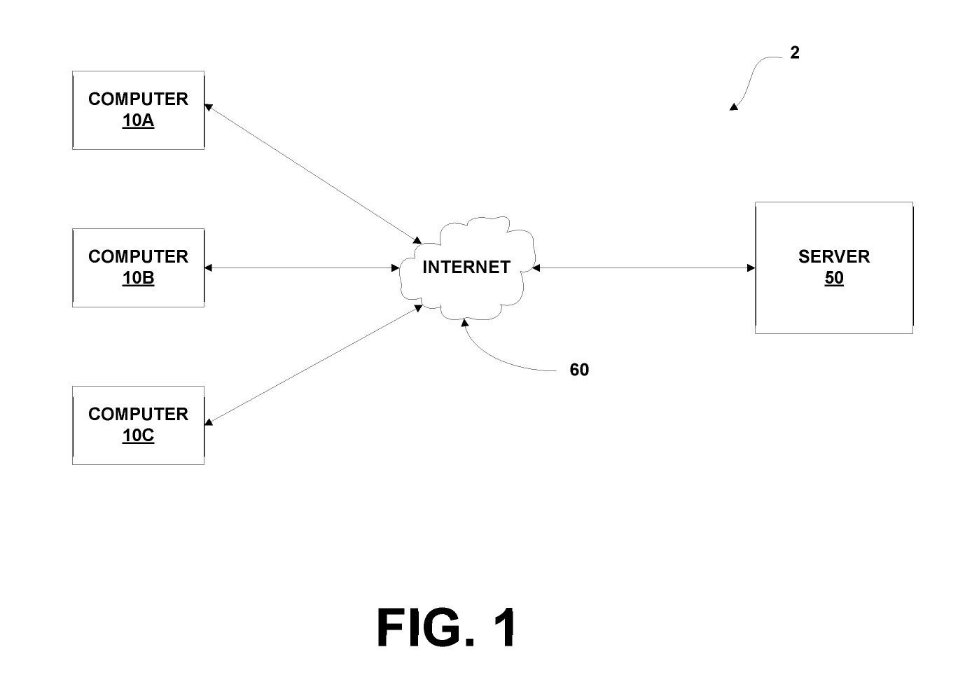

The present system and method is provided within a client/server network. FIG. 1 is a schematic diagram illustrating an exemplary network 2 in accordance with the present system and method. As shown by FIG. 1, the network 2 contains multiple computers 10A, 10B, 10C. A computer 10 may be one of many different processing devices such as, but not limited to, a general purpose standalone computer, a smart phone, or a different processing device.

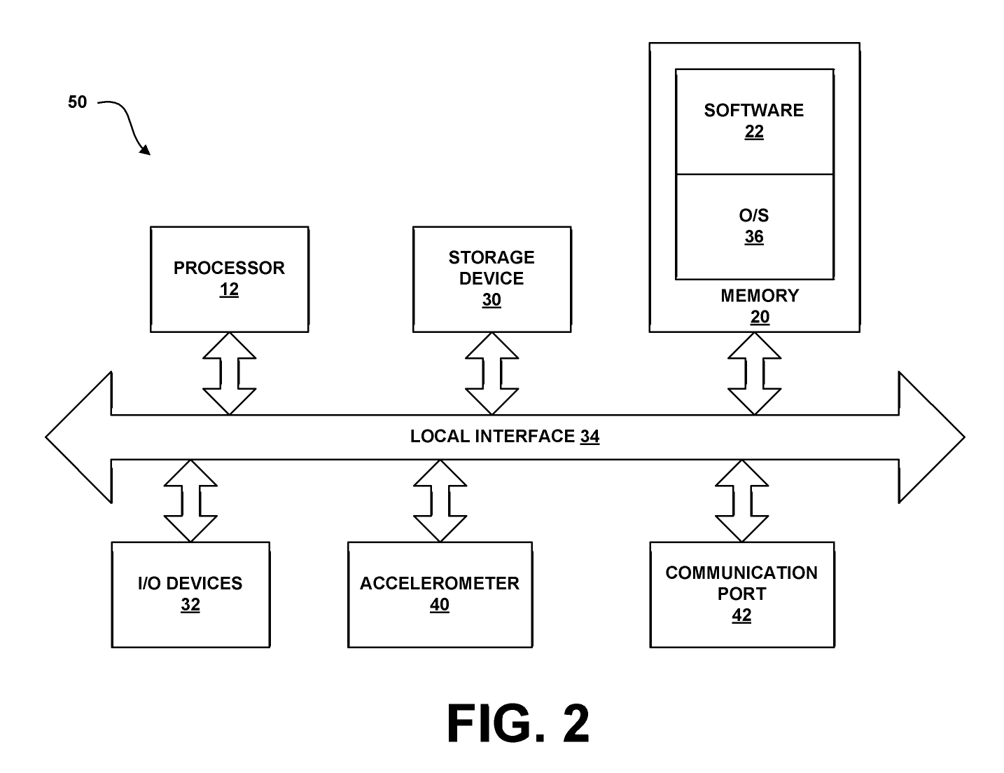

Returning to FIG. 1, the exemplary embodiment of the network 2 illustrates that each of the computers 10 communicates with a server 50. A detailed description of one example of a server 50 is provided with regard to the description of FIG. 2. The computers 10 may communicate with the server 50 via use of one or more communication protocol provided by a transmission means 60, which is known to one having ordinary skill in the art. As a non-limiting example, the computer 10 may communicate with the server 50 via the Internet 60. It should be noted that, within the network, communication may be from the computers 10 to the server 50, or from the server 50 to one or more of the computers 10.

Functionality of the server 50 can be implemented in software, firmware, hardware, or a combination thereof. In a first exemplary embodiment, a portion of the server 50 is implemented in software, as an executable program. The first exemplary embodiment of a server 50 is shown in FIG. 2. It should be noted that for simplicity, the server 50 is illustrated as having similar components to a general purpose computer.

Generally, in terms of hardware architecture, as shown in FIG. 2, the server 50 includes a processor 12, memory 20, storage device 30, and one or more input and/or output (I/O) devices 32 (or peripherals) that are communicatively coupled via a local interface 34. The local interface 34 can be, for example, but not limited to, one or more buses or other wired or wireless connections, as is known in the art. The local interface 34 may have additional elements, which are omitted for simplicity, such as controllers, buffers (caches), drivers, repeaters, and receivers, to enable communications. Further, the local interface 34 may include address, control, and/or data connections to enable appropriate communications among the aforementioned components.

The processor 12 is a hardware device for executing software, particularly that stored in the memory 20. The processor 12 can be any custom made or commercially available processor, a central processing unit (CPU), an auxiliary processor among several processors associated with the server 50, a semiconductor based microprocessor (in the form of a microchip or chip set), a macroprocessor, or generally any device for executing software instructions.

The memory 20 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 20 may incorporate electronic, magnetic, optical, and/or other types of storage media. Note that the memory 20 can have a distributed architecture, where various components are situated remote from one another, but can be accessed by the processor 12.

The software 22 in the memory 20 may include one or more separate programs, each of which contains an ordered listing of executable instructions for implementing logical functions of the server 50, as described below. In the example of FIG. 2, the software 22 in the memory 20 defines the server 50 functionality in accordance with the present invention. In addition, although not required, it is possible for the memory 20 to contain an operating system (O/S) 36. The operating system 36 essentially controls the execution of computer programs and provides scheduling, input-output control, file and data management, memory management, and communication control and related services.

The server 50 may be provided by a source program, executable program (object code), script, or any other entity containing a set of instructions to be performed. When a source program, then the program needs to be translated via a compiler, assembler, interpreter, or the like, which may or may not be included within the memory 20, so as to operate properly in connection with the O/S 36. Furthermore, the server 50 can be written as (a) an object oriented programming language, which has classes of data and methods, or (b) a procedure programming language, which has routines, subroutines, and/or functions.

The I/O devices 32 may include input devices, for example but not limited to, a touch screen, a keyboard, mouse, scanner, microphone, or other input device. Furthermore, the I/O devices 32 may also include output devices, for example but not limited to, a display, or other output devices. The I/O devices 32 may further include devices that communicate via both inputs and outputs, for instance but not limited to, a modulator/demodulator (modem; for accessing another device, system, or network), a radio frequency (RF), wireless, or other transceiver, a telephonic interface, a bridge, a router, or other devices that function both as an input and an output. I/O devices 32 are used to transmit the smart messages from the vehicle to the server 50.

When the server 50 is in operation, the processor 12 is configured to execute the software 22 stored within the memory 20, to communicate data to and from the memory 20, and to generally control operations of the server 50 pursuant to the software 22. The software 22 and the O/S 36, in whole or in part, but typically the latter, are read by the processor 12, perhaps buffered within the processor 12, and then executed.

When the server 50 is implemented in software, as is shown in FIG. 2, it should be noted that the server 50 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The server 50 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The storage device 30 of the server 50 may be one of many different types of storage device, including a stationary storage device or portable storage device. As an example, the storage device 30 may be a magnetic tape, disk, flash memory, volatile memory, or a different storage device. In addition, the storage device may be a secure digital memory card or any other removable storage device 30. In addition, as is typical with most servers, there may be more than one storage device within the server 50.

The following flow charts further describe how the present system and method is able to achieve real-time, geo-referenced (e.g., spatially anchored) collaboration. It should be noted that any process descriptions or blocks in flow charts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

It should be noted that, at each computer 10, there is no need for any proprietary software or hardware to use the technology of the present system and method. In addition, no specific operating system is required. Users only need to possess a compatible Web browser and an Internet connection (wired or wireless). Users can use this technology on workstations, laptops, and any other Web enabled devices (e.g., smartphones, etc.).

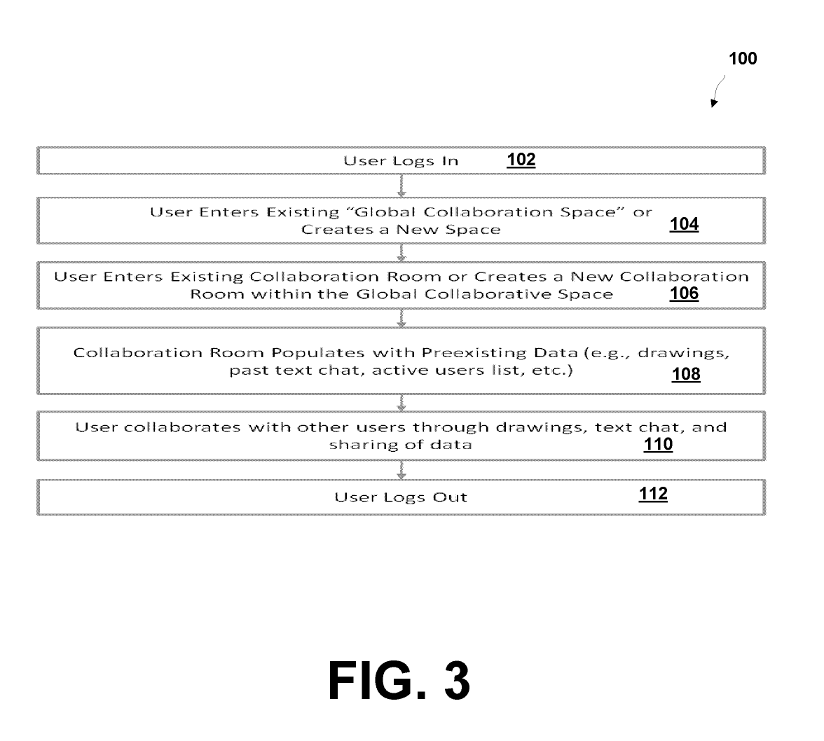

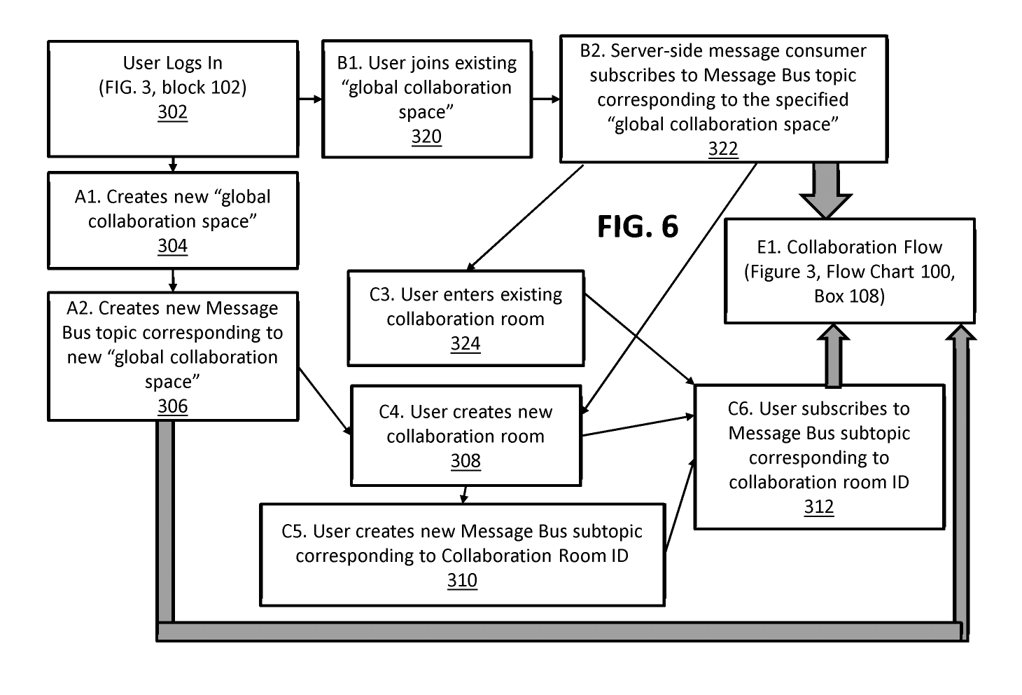

FIG. 3 is a flow chart 100 providing a high-level flow of a user interacting with the present system and method. As shown by block 102, a user logs into the server 50 to use the present system. As an example, a user may log into a Web site via his/her computer 10. The user then enters an existing global collaboration space or creates a new global collaboration space (block 104). As an example, a global collaboration space may be defined by a subject matter, with an associated portion of a background image associated with the subject matter. For example, a subject matter might be “Haiti Disaster” and the background image may be a map of the world associated with the Haiti Disaster. As shown by block 106, the user then either enters an existing collaboration room or creates a new collaboration room within the global collaborative space. FIG. 6 is a flow chart further describing steps taken in accordance with blocks 104 and 106.

Returning to FIG. 3, the collaboration room then populates with preexisting data, such as, but not limited to, drawings, past text chat, an active users list, or other preexisting data (block 108). As shown by block 110, the user then collaborates with other users through drawings, text chat, sharing of data, or other means of collaboration. The user may then log out (block 112).

The global collaboration spaces and collaboration rooms are created through use of unique message bus topics and the persisting of related data to a database, with use of a header identifying any global collaboration space name and/or collaboration room name. Any user can register a new global collaboration space or collaboration room; the process merely requires a unique name to be given to the collaboration space or collaboration room. To create a new global collaboration space, when instructed to do so by the user, the server 50 creates a new message bus topic on the server 50 with the name corresponding to the new global collaboration space, as provided by the user.

When a new collaboration space or collaboration room is created, information such as the topic name and subtopic name is persisted, which can then be used to reconstruct the unique topic that belongs to the collaboration space or collaboration room for rendering on the screen of a second user located separate from the first user. At the same time as the registration of the collaboration room or collaboration space completes, the user is subscribed to the corresponding topic on the message bus, thus creating a virtual, sandboxed area within the message bus for the collaboration space or data of the collaboration room. When new users want to join the new collaboration space or collaboration room, they simply look up the names of collaboration spaces and/or rooms, and choose which to join. The database lookup allows retrieving of the unique topic and subscribing the user to the topic, thus bringing the user into the new collaboration space or collaboration room. Specifically, after a user has created a new collaboration space and provided an associated name, the name may be searched by other users of the present system and method.

It should be noted that the present description uses the relationship of a global collaboration space having a topic name, while a collaboration room has a subtopic name. In addition, as is explained in further detail herein, massages transmitted by users within a collaboration space or collaboration room are transmitted with a header. Specifically, messages transmitted within a global collaboration space contain a header and a payload. For identification purposes, the header contains the topic name and the subtopic name, while the payload contains the data being transmitted, such as, but not limited to, encoded vectors for rendering of vector objects.

Actions between the user (“Client”) and server may be passed in messages on the message bus. Since one having ordinary skill in the art would know what a message bus is and that it is used in publish/subscribe messaging, a detailed description of the same is not provided herein. As one example, the Advanced Message Queuing Protocol, an Open Standard for Messaging Middleware, may be used. The present use of message bus topics allows information to be sandboxed according to the “global” collaboration spaces and rooms. The topic is essentially the “address” to which a message is sent. Only users who have subscribed to a particular topic can retrieve the messages sent to the topic. As each space or room is given a unique identifier (e.g., name), that identifier can be used to constrain the distribution of the information generated in the space or room. Thus, all information generated and shared in the “global” collaboration space will be shared with only the users currently in that space, and likewise for the individual collaboration rooms.

### Client-Server Communication for Message Bus Interaction

In order to allow the client to be free of any proprietary software necessarily being installed on an associated computer 10, communication from the client to the message bus must be proxied through the server 50. Normally an application connecting to the message bus would communicate directly to the message bus via a message bus end-client. However, this would require specialized software to be placed on the client machine (e.g., computer 10). So instead, within the code running in the Web Browser, a proxy is set up that makes HTTP calls to a component on the server 50. The interaction between the proxy and server-side component is facilitated through a process known as “remoting” implemented in the Seam Remoting library. A proxy is created for both the “consumer” and the “producer” components. When a client wants to send a message onto the message bus, it uses the “producer” proxy, which triggers a server-side component to execute its “send” method, which places the specified message onto the message Bus. Similarly, for retrieving messages from the message bus, there is a server-side component. This “consumer” component receives any messages intended for the client and stores them in memory. When the client wants to retrieve these messages, it uses the “consumer” proxy component to execute the server-side component's “retrieve” method, which returns all stored messages to the client. Then the stored messages are cleared from memory, and the server-side component begins storing new incoming messages for the client.

FIG. 6 is a flow chart 300 further describing steps taken in accordance with blocks 104 and 106, specifically, the creating and/or joining of global collaboration spaces and/or rooms. As shown by block 302, the user logs into the server. Block 302 corresponds to block 102 of FIG. 3. The creation of a new global collaboration space is the A route illustrated by FIG. 6, while the joining of an existing global collaboration space is the B route. If the user chooses to create a new global collaboration space (block 304), the user provides the server 50 with a new message bus topic corresponding to the new global collaboration space, which will be used to identify the new global collaboration space (block 306). Messages (i.e., information) shared within the new global collaboration space would only be distributed among users subscribed to the topic identifying the new global collaboration space.

The user may then create a collaboration room within the global collaboration space (block 308). During creation of a new collaboration room, the user creates a new massage bus subtopic corresponding to the collaboration room identification (block 310). The user is then subscribed to the message bus subtopic corresponding to the collaboration room identification (block 312). Messages (i.e., information) shared within the new collaboration room are only distributed among users subscribed to the collaboration room subtopic.

Instead of creating a new global collaboration space, a user may select to join an existing global collaboration space (block 320). If the user selects to join an existing global collaboration space, such as by selecting a space from a list provided to the user for selection, the server-side message consumer subscribes to the message bus topic corresponding to the specified global collaboration space (block 322). Messages (i.e., information) shared in the global collaborative space is only distributed among users subscribed to the topic.

The user may then either select to enter an existing collaboration room (block 324) or create a new collaboration room (block 308—previously described). If the user selects to enter an existing collaboration room, such as by selecting a room from a list provided to the user for selection, the user is then subscribed to the message bus subtopic corresponding to the collaboration room identification (block 312). Blocks 312 and 322 continue with block 108 of the flow chart of FIG. 3.

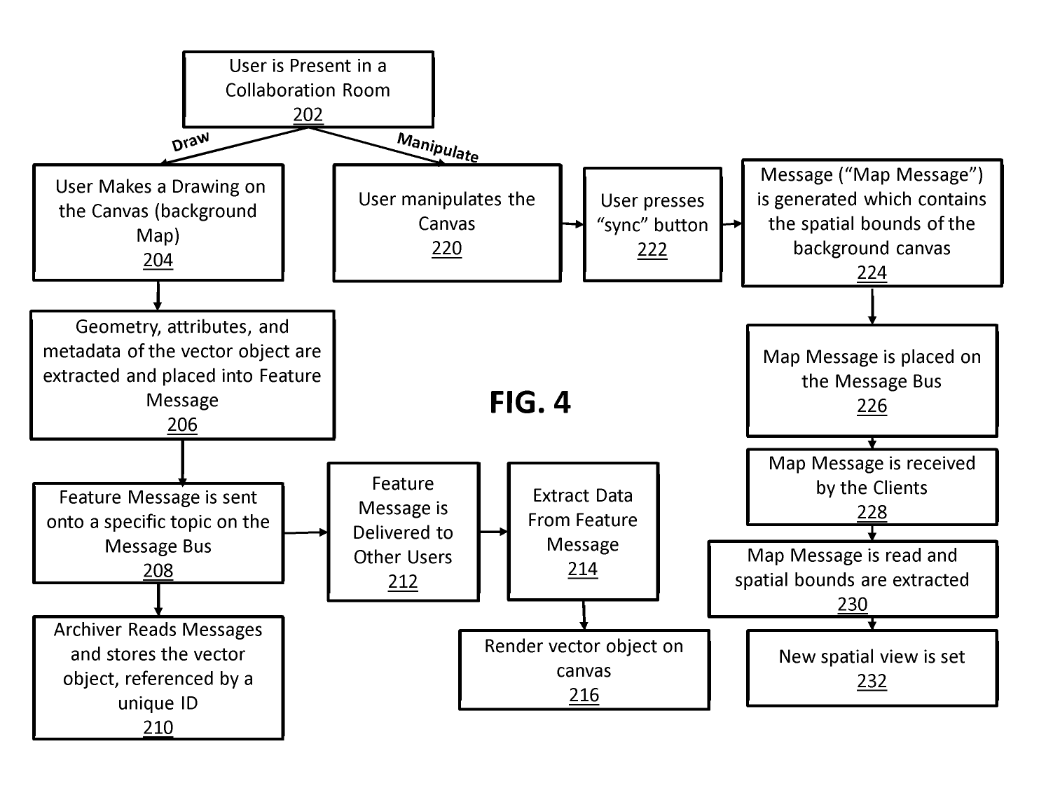

FIG. 4 is a flow chart 200 illustrating details and methods for how real-time, geo-referenced collaboration is achieved in accordance with the present invention. Once in a collaboration room (block 202), a user can either send text chats, draw or manipulate a background canvas (e.g., map or image). The following provides details regarding how drawing and manipulation is handled by the present invention.

It should be noted that the background canvas may be previously stored on the server 50 and selectable by the user for use in accordance with the present invention. Upon selection, the user may associate the background canvas with a specific global collaboration space and/or collaboration room. Alternatively, the user may select to upload a background canvas to the server 50 for association with a specific global collaboration space and/or collaboration room.

As shown by FIG. 4, the user is present in a collaboration room (block 202). For drawing, as shown by block 204, the user makes a drawing on the canvas (background map). The drawing is a vector object with a given geometry, attributes, and metadata.

Geometry, attributes, and metadata of the vector object are extracted and placed into a message, referred to herein as a feature message (block 206). It should be noted that the feature message contains the header and payload as previously described. As previously mentioned, the header contains the topic name and the subtopic name, while the payload contains the data being transmitted. Herein, geometry, attributes, and metadata of the vector object are also referred to as properties of the vector object. An example of how to create a feature message includes the following steps: 1) using a software library for displaying maps (for example, OpenLayers), a vector object is drawn on the map; 2) add a number of properties to the vector object, which store style information and other metadata; 3) the vector object contains geometry data, which may be written to a “Well Known Text” (WKT) string; 4) within the feature message (which, for example, may be created as a Javascript object and then transformed into a JavaScript Object Notation (JSON) string), add a field that contains the WKT string (i.e., the feature's geometry in string form) and a field listing the metadata of the vector object (this contains styling info for example); and 5) once the Javascript object is converted to a JSON string, send it out onto the message bus.

As shown by FIG. 4, the feature message is then sent onto a specific topic on the message bus (block 208). An archiver then reads messages and stores the vector object, references by a unique ID (block 210). Reading a feature message includes the following steps: 1) parse the JSON string message back into a Javascript object; 2) geometry data is stored as a WKT string, which is a standard format, so one can easily convert this string into a geometry object that OpenLayers can use to draw the feature; 3) create an OpenLayers feature using the geometry object from above and the attributes that are stored in our feature message; and 4) draw this feature on the map, using the OpenLayers library.

As shown by block 212, the feature message is delivered to other users. Data is then extracted from the feature message (block 214). The vector object is then rendered on the canvas (block 216).

For manipulating the canvas, as shown by block 220, the user manipulates the canvas (e.g., pans/zooms the map to a specific location). The user selects a “sync” button (block 222). A message is then generated (referred to as a “map message”), which contains the spatial bounds of the background canvas (block 224). To create the map message, the following steps are performed: 1) when the user clicks the Map Sync button, capture the geographic bounds of the current window using OpenLayers functions; and 2) add these bounds as a string to the map message and send it out on the message bus.

The map message is then placed on the message bus (block 226), after which the map message is received by the clients (block 228). As shown by block 230, the map message is then read and spatial bounds are extracted. Reading of a map message is performed by the following steps of: 1) reading in the map message and obtaining geographic bounds as a string from the message; and 2) using OpenLayers functions, setting the bounds of the map of the user to the bounds described by the string. The new spatial view is then set (block 232).

In order for the various messages (e.g., presence message, feature message and map message) to be sent to only those users subscribed and present in the particular collaboration rooms, the following exemplifies a hierarchy of topics that may be used on the message bus.

### Topic/Sub-Topic Organization of the Message Bus

| | |
|---|---|
| | Top Hierarchy |

◯ctrl [for system-wide control messages]
◯alert [for system-wide alert messages]

▪ email [for email alert messages]
▪ sadisplay [for alert messages designated for

sadisplay consumption]

◯incidents [incidents namespace]

▪ <incident-name> [sub-topic for each specific

incident]

| | |
|---|---|
| | other [for non-collaboration, |

incident-wide messages, such as incident
status reports]

| | |
|---|---|
| ◯ | roc [report on conditions |

messages]

| | |
|---|---|
| ◯ | resource [resources messages] |

| | |
|---|---|
| | collab [collaboration namespace] |

| | |
|---|---|
| ◯ | <room-name> [sub-topic for each |

collaboration room within an
incident]

◯noincident [namespace for messaging when users have
no incident selected]

▪ other [for non-collaboration messages to be

sent out to all users not within an incident]

 roc [report on conditions messages]
 resource [resources messages]

▪ collab [collaboration namespace]

 <room-name> [sub-topic for each
collaboration room without an incident]

For example, if a user is in the “LLTest” Collaboration Room, the Client will be listening for messages in the “LLTest” Collaboration Room within the “LLTestIncident” global Collaborative Space, and the routing pattern would be “LDDRS.incidents.LLTestIncident.collab.LLTest”.

The following provides an example of a feature message.

### Example Feature Message:

{
“feat”:

{
“id”:<id_string>,
“from”:

{
“user”:<user_string>,
“nick”:<nickname_string>
},

“type”:<feature_command_type>,
“content”: <command_string> || <packed_feature> ||

<attributes_object> || null

},

“room”:<room/topic_string>,
“time”:<date_string>,
“ver”:<version_number: major.minor.revision>,
“ip”:<ip_address>,
“seqtime”:<long, auto-generated>,
“seqnum”:<integer, auto-generated>,
“topic”:<string, full topic pattern>
}
<feature_command_type> = ‘move’ || ‘draw’ || ‘remove’ ||
‘modify’
<command_string> = the move instructions -- a string
representing the lat and lng
<packed_feature> = a packed version of the feature, as
follows:

{
“attrs”: an object containing name-value pairs for

feature attributes, such as styling attrs, creator attr,
timestamp, etc

“geo”: a stringified version of the features

geometry, created by a call to
Feature.Geometry.toString( );

}

<attributes_object> = an object containing key-value
pairs that correspond to properties of the
feature.attributes object

The following provides an example of a feature draw massage.

### Example Feature Draw Message

{
“feat”:

{
“id”:“OpenLayers.Feature.Vector_6702admin”,
“from”:{“user”:“admin”,“nick”:“admin”},
“type”:“draw”,
“content”:

{
“attrs”:

{
“type”:“polygon”,
“created”:“2010031613:42:05”,
“eventname”:“default”,
“user”:“admin”,
“opacity”:0.4,
“strokeWidth”:“2”,
“dashStyle”:“solid”,
“strokeColor”:“#FF0000”,
“fillColor”:“#FF0000”,
“pointRadius”:2,
“hasGraphic”:false,
“graphic”:“”,
“graphicWidth”:0,
“graphicHeight”:0,
“labelText”:“”
},

“geo”:“POLYGON((−13050858.207594

4016842.2728551,−13050934.644623 4016460.0877138,−
13051087.518679 4016077.9025724,
−13051240.392736 4016001.4655441,−13051240.392736
4015772.1544593,−13051240.392736 4015619.2804028,−
13051240.392736 4015466.4063462,
−13051163.955707 4015389.9693179,−13051087.518679
4015313.5322897,−13050934.644623 4015313.5322897,−
13050781.770566 4015313.5322897,
−13050476.022453 4015313.5322897,−13049940.963255
4015466.4063462,−13049635.215142 4015542.8433745,−
13049329.467029 4015619.2804028,
−13049100.155944 4015772.1544593,−13048947.281887
4015772.1544593,−13048947.281887 4015848.5914876,−
13048947.281887 4015925.0285159,
−13049100.155944 4015925.0285159,−13049176.592972
4016077.9025724,−13049253.030001 4016154.3396007,−
13049329.467029 4016307.2136572,
−13050858.207594 4016842.2728551))”

}

},

“room”:“TestIncident-test_room1”,
“time”:“2010-16-03 17:29:05”,
“ver”:“1.0.1”,
“ip”:“127.0.0.1”,
“seqtime”:1281638761157,
“seqnum”:327,
“topic”:“LDDRS.incidents.TestIncident.collab.test_room1”
}

The following provides an example of a feature move message.

### Example Feature Move Message

{
“feat”:

{
“id”:“OpenLayers.Feature.Vector_294admin”,
“from”:

{
“user”:“admin”,
“nick”:“admin”
},

“type”:“move”,
“content”:“−13055291.555234, 4001401.9931437”
},

“room”:“TestIncident-test_room1”,
“time”:“2010-16-03 17:29:05”,
“ver”:“1.0.1”,
“ip”:“127.0.0.1”,
“seqtime”:1281638761157,
“seqnum”:327,
“topic”:“LDDRS.incidents.TestIncident.collab.test_room1”
}

The following provides an example of a feature delete message.

### Example Feature Delete Message

{
“feat”:

{
“id”:“OpenLayers.Feature.Vector_465admin”,
“from”:

{
“user”:“admin”,
“nick”:“admin”
},

“type”:“remove”,
“content”:null
},

“room”:“TestIncident-test_room1”,
“time”:“2010-16-03 17:29:05”,
“ver”:“1.0.1”,
“ip”:“127.0.0.1”,
“seqtime”:1281638761157,
“seqnum”:327,
“topic”:“LDDRS.incidents.TestIncident.collab.test_room1”
}

The following provides an example of a feature modify message.

### Example Feature Modify Message

{
“feat”:

{
“id”:“OpenLayers.Feature.Vector_465admin”,
“from”:

{
“user”:“admin”,
“nick”:“admin”
},

“type”:“modify”,
“content”:

{
“rotation”:45
}

},

“room”:“TestIncident-test_room1”,
“time”:“2010-16-03 17:29:05”,
“ver”:“1.0.1”,
“ip”:“127.0.0.1”,
“seqtime”:1281638761157,
“seqnum”:327,
“topic”:“LDDRS.incidents.TestIncident.collab.test_room1”
}

The following provides an example of a message to sync map canvas views.

### Example Message to Sync Map Canvas Views

{
“map”:

{
“from”:

{
“user”:<user_string>,
“nick”:<nickname_string>
},

“bounds”:<bounds_string>,
“proj”:<proj_code_string>
}

“room”: <room/topic_string>,
“time”: <date_string>,
“ver”:<version_number: major.minor.revision>,
“ip”:<ip_address>
}
e.g.
{
“map”:

{
“from”:

{
“user”:“admin”,
“nick”:“admin”
},

“bounds”:“−13168724.105188, 3818488.1844849,

924737.110946, 3947513.8882071”,

“proj”:“EPSG:900913”
}

“room”: “TestIncident-testroom”,
“time”: “2010-16-03 17:29:05”,
“ver”:“1.0.1”,
“ip”:“127.0.0.1”,
“seqtime”:1281638761157,
“seqnum”:327,
“topic”:“LDDRS.incidents.TestIncident.collab.test_room1”
}

The following provides an example of a chat message for text chatting.

### Example Chat Message for Text Chatting

{
“msg”:

{
“id”:<id_number>,
“from”:

{
“user”:<user_string>,
“nick”:<nickname_string>,
“org”:<organization_string>
},

“body”:<body_string>
},

“room”:<room/topic_identifier>,
“time”:<date_string>,
“ver”:<version_number: major.minor.revision>,
“ip”:<ip_address>,
“seqtime”:<long, auto-generated>,
“seqnum”:<integer, auto-generated>,
“topic”:<string, full topic pattern>
}
e.g.
{
“msg”:

{
“id”:13564897546478,
“from”:

{
“user”:“admin”,
“nick”:“admin”,
“org”:“MITLL”
},

“body”:“still getting my messages?”
},

“room”:“TestIncident-test_room1”,
“time”:“2010-16-03 17:29:05”,
“ver”:“1.0.1”,
“ip:”:“127.0.0.1”,
“seqtime”:1281638761157,
“seqnum”:327,
“topic”:“LDDRS.incidents.TestIncident.collab.test_room1”
}

### Presence Message

The following is an example of a presence message, sent by the Client to inform other users when a user's presence in a collaboration room changes.

{

“pres”:{

“type”:<presence_type>,
“states”:{

<username>:{

“state”:<state>,
“metadata”:{

<field>:<value>,
...

}

},

...
}

},
“user”:“collabmanagercomp”,
“room”:<room/topic_identifier>,
“time”:<date_string>,
“ver”:<version_number:major.minor.revision>,
“ip”:<ip_address>,
“seqtime”:<long, auto-generated>,
“seqnum”:<integer, auto-generated>,
“topic”:<string, full topic pattern>

}
where <presence_type> = “diff” || “full” (indicating
whether this is a complete view of the room state or just
a diff from the previous diff view)
e.g.
{

“pres”:{

“type”:“diff”,
“states”:{

“rayd”:{

“state”:“active”,
“metadata”:{

“org”:“MITLL”,
...

}

},
“pbreimyer”:{

“state”:“active”

}

}

},
“user”:“collabmanagercomp”,
“room”:“TestIncident-test_room1”,
“time”:“2010-16-0317:29:05”,
“ver”:“1.0.2”,
“ip”:“127.0.0.1”,
“seqtime”:1281638761157,
“seqnum”:327,

“topic”:“LDDRS.incidents.TestIncident.collab.test_room1”
}
metadata should be as follows (subject to change):
{

“org”:“MITLL”,
“firstname”:“Ray”,
“lastname”:“Di Ciaccio”

}

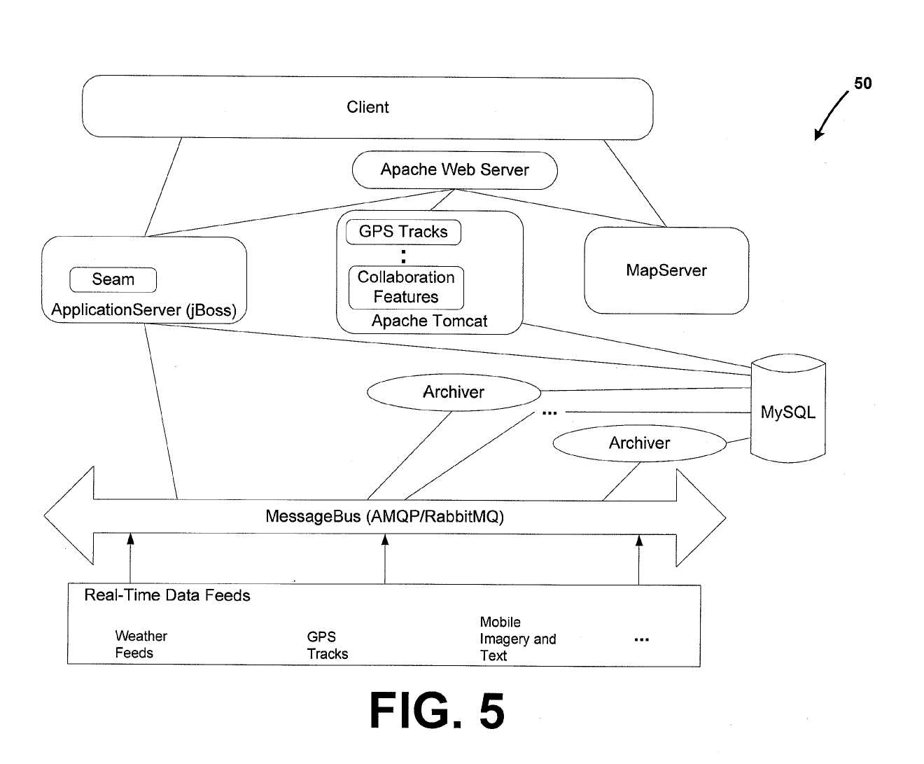

FIG. 5 is an example of the network of a software stack of the server 50 in accordance with an alternative embodiment of the invention. FIG. 5 shows one potential software stack that can be used to implement this invention, while many others may be used. The “producer” and “consumer” proxies are implemented as Java Beans running in the Application Server (see FIG. 5). The client 500, or web browser, makes an HTTP request to use either the “producer” or “consumer” through the Apache Web Server, which directs the request to the JBoss Application Server (AS). The AS handles this request in the context of the inventive web-application, which is using the Seam Remoting Application Programming Interface (API). The Seam Remoting API interprets the request and calls the corresponding method on the specified Java Bean. Both the “producer” and “consumer” Java Beans are connected to the message bus and interact with it directly, either sending or retrieving messages based on the type of request from the client. In this way, a message passes from the client, to the “producer” Java Bean running within the AS, and out onto the Message Bus; or in the reverse direction, it passes from the Message Bus, into the “consumer” Java Bean running within the AS, and back to the Client.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

We claim:

1. A system for providing an image-referenced virtual collaborative environment, comprising:
a server in communication with at least a first client device and a second client device, wherein the server comprises:
a memory; and
a processor configured by the memory to perform the steps of:
extracting properties of a vector object, where the vector object is the result of a modification to a first background image performed by a first user on the first client device;
placing the extracted properties of the vector object into a feature message;
sending the feature message onto a specific topic on a message bus;
delivering the feature message to a second user using the second client device;
extracting data from the feature message; and
rendering, in real time, the vector object on a second background image viewed by the second user via the second client device.

2. The system of claim 1, wherein a modification to a background image is selected from the group consisting of drawing on the background image and manipulating the image.

3. The system of claim 1, wherein the background image is a map.

4. The system of claim 1, wherein the first background image and the second background image are the same image.

5. The system of claim 1, wherein the feature message contains a header and a payload, wherein the header includes an identification of a topic associated with a collaboration space which the first user and the second user are logged into.

6. A method of providing an image-referenced virtual collaborative environment, comprising the steps of:
extracting properties of a vector object, where the vector object is the result of a modification to a first background image performed by a first user on a first client device;
placing the extracted properties of the vector object into a feature message;
sending the feature message onto a specific topic on a message bus;
delivering the feature message to a second user using a second client device;
extracting data from the feature message; and
rendering, in real time, the vector object on a second background image viewed by the second user via the second client device.

7. The method of claim 6, wherein properties of the vector object are selected from the group consisting of geometry, attributes, and metadata.

8. The method of claim 6, wherein a modification to a background image is selected from the group consisting of drawing on the background image and manipulating the image.

9. The method of claim 6, wherein the image is a map.

10. The method of claim 6, wherein the feature message contains a header and a payload, wherein the header includes an identification of a topic associated with a collaboration space which the first user and the second user are logged into.

11. The method of claim 6, wherein the first background image and the second background image are the same image.
